(19) United States
(12) Patent Application Publication
(10) Pub. No.: US 2014/0118777 A1
(43) Pub. Date: May 1, 2014

(54) IMAGE FORMING SYSTEM, IMAGE FORMING APPARATUS, AND IMAGE FORMING METHOD

(71) Applicant: FUJI XEROX CO., LTD., Tokyo (JP)

(72) Inventor: Masakazu YAMAMOTO, Yokohama-shi (JP)

(21) Appl. No.: 13/917,760

(22) Filed: Jun. 14, 2013

(30) Foreign Application Priority Data
Oct. 30, 2012 (JP) 2012-239206

(51) Int. Cl. G06F 3/12

(52) U.S. Cl. CPC G06F 3/1296
USPC 358/1.15

(57) ABSTRACT

An image forming apparatus, includes: a communication unit that communicates with a server apparatus and another image forming apparatus; an identification unit that identifies a user of a local device as the image forming apparatus; a request transmission unit that transmits a request to check a state to another image forming apparatus through the communication unit; a data acquisition unit that, when a result of a response for the request indicates that an error occurs in said another image forming apparatus, obtain image data of the user who is identified by the identification unit from the server apparatus through the communication unit; and an image forming unit that forms an image in accordance with the image data acquired by the data acquisition unit.

### CROSS-REFERENCE TO RELATED APPLICATIONS

This application is based on and claims priority under 35 U.S.C. 119 from Japanese Patent Application No. 2012-239206 filed on Oct. 30, 2012.

### BACKGROUND

1. Technical Field

The present invention relates to an image forming system, an image forming apparatus, and an image forming method.

2. Related Art

A system which is capable of outputting its own document data from any of printers has been suggested.

### SUMMARY

According to an aspect of the invention, an image forming system, includes: a server apparatus; and a plurality of image forming apparatuses, in which the server apparatus includes: an acquisition unit that, when image data of a user is transmitted from a client apparatus to any one of the plurality of image forming apparatus, obtains the image data from the client apparatus or the image forming apparatus which is a destination of the image data; and a first storage unit that stores the image data acquired by the acquisition unit, each of the plurality of image forming apparatuses, includes: a second storage unit that stores the image data which is transmitted from the client apparatus to a local device as the image forming apparatus; an identification unit that identifies a user of the local device; a request transmission unit that transmits a request to check a state of another image forming apparatus; a data acquisition unit that, when a result of a response for the request indicates that an error occurs in said another image forming apparatus, obtains image data of the user who is identified by the identification unit from the server apparatus; and an image forming unit that forms an image in accordance with the image data acquired by the data acquisition unit.

### BRIEF DESCRIPTION OF THE DRAWINGS

Exemplary embodiment(s) of the present invention will be described in detail based on the following figures, wherein

FIG. 1 is a view illustrating an entire configuration of an image forming system;

FIG. 2 is a view illustrating a hardware configuration of a client apparatus;

FIG. 3 is a view illustrating a hardware configuration of an image forming apparatus;

FIG. 4 is a view illustrating a hardware configuration of a server apparatus;

FIG. 5 is a view illustrating functional components of an image forming system;

FIG. 6 is a sequence chart illustrating a printing processing in a normal state;

FIG. 7 is a view illustrating a database which manages document data;

FIG. 8 is a view illustrating a list of the document data;

FIG. 9 is a sequence chart illustrating a printing processing in an abnormal state;

FIG. 10 is a view illustrating a list of the document data; and

FIG. 11 is a view illustrating a deletion list.

### DETAILED DESCRIPTION

[Configuration]

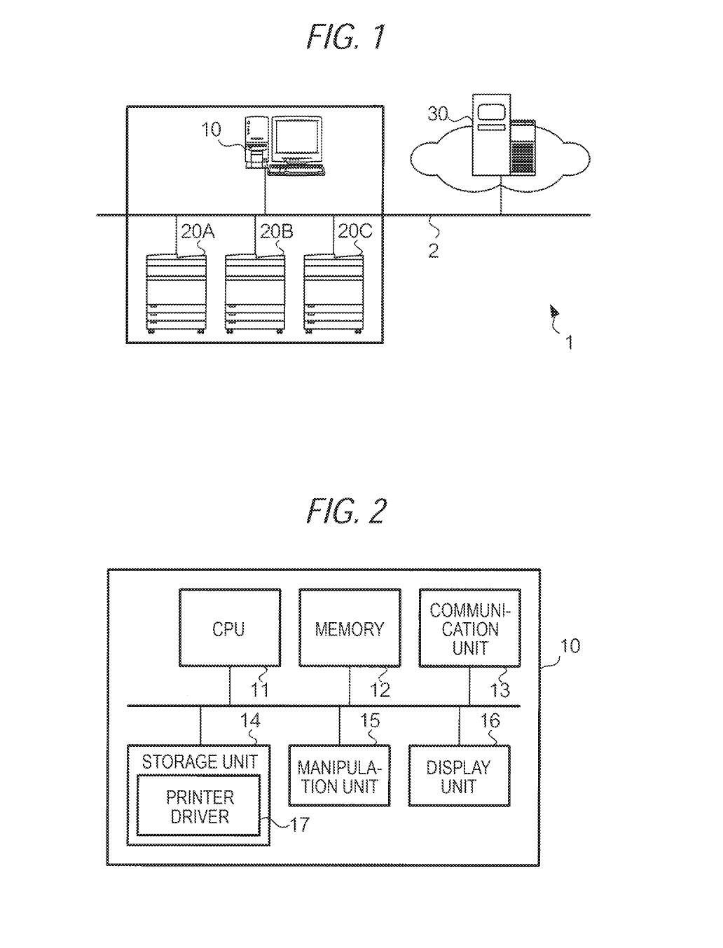

FIG. 1 is a view illustrating an entire configuration of an image forming system 1. The image forming system 1 includes a client apparatus 10, image forming apparatus 20A, 20B, and 20C (hereinafter, collectively referred to as “image forming apparatus 20”), and a server apparatus 30. The client apparatus 10, the image forming apparatus 20, and the server apparatus 30 are connected to each other through a communication line 2. The communication line 2 includes, for example, a LAN (local area network) and an Internet which are connected to each other.

The client apparatus 10 and the image forming apparatus 20 are, for example, connected to the LAN and the server apparatus 30 is, for example, connected to the Internet.

FIG. 2 is a view illustrating a hardware configuration of the client apparatus 10. The client apparatus 10 includes a CPU 11, a memory 12, a communication unit 13, a storage unit 14, a manipulation unit 15, and a display unit 16. The CPU 11 executes a program to perform various processings. The memory 12 includes, for example, a ROM and a RAM. The memory 12 stores a program or data which is executed by the CPU 11. The communication unit 13 communicates with the image forming apparatus 20 through the communication line 2. The storage unit 14, for example, includes a hard disk. The storage unit 14 stores a printer driver 17. The printer driver 17 is a program which generates document data to be printed at the image forming apparatus 20. The manipulation unit 15, for example, includes a keyboard and a mouse. The manipulation unit 15 inputs information in accordance with the manipulation by a user to the CPU 11. The display unit 16, for example, includes a liquid crystal display. The display unit 16 displays information such as a character or an image.

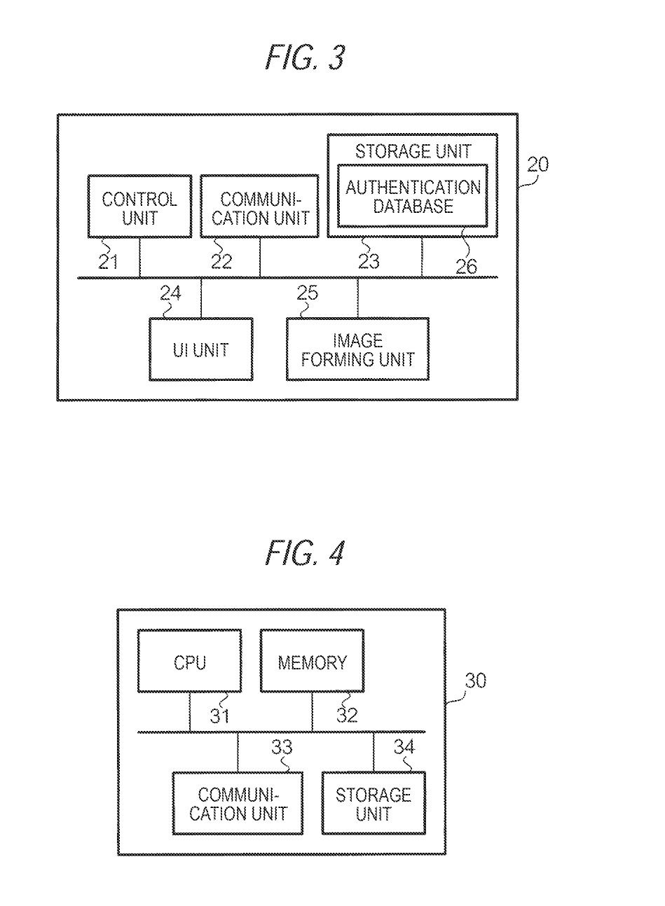

FIG. 3 is a view illustrating a hardware configuration of the image forming apparatus 20. The image forming apparatus 20 includes a control unit 21, a communication unit 22, a storage unit 23, a UI unit 24, and an image forming unit 25. The control unit 21, for example, includes a CPU and a memory. The control unit 21 controls each component of the image forming apparatus 20. The communication unit 22 communicates with the client apparatus 10 or the server apparatus 30 through the communication line 2. The storage unit 23, for example, includes a hard disk. The storage unit 23 stores an authentication database 26 which is used to authenticate a user. A set of a user ID and a password of a properly authorized user for the image forming apparatus 20 is registered in advance in the authentication database 26. Further, the storage unit 23 stores document data which is transmitted from the client apparatus 10 to a local device. The UI unit 24, for example, includes a touch panel and a manipulation button. The UI unit 24 displays information such as a character or an image and inputs information in accordance with the manipulation by the user to the control unit 21. The image forming unit 25 forms an image on a recording medium such as a paper sheet in accordance with the document data. The image forming unit 25, for example, forms an image electro-photographically.

FIG. 4 is a view illustrating a hardware configuration of the server apparatus 30. The server apparatus 30 includes a CPU 31, a memory 32, a communication unit 33, and a storage unit 34. The CPU 31 executes a program to perform various processings. The memory 32, for example, includes a ROM and a RAM. The memory 32 stores a program or data which is executed by the CPU 31. The communication unit 33 communicates with the image forming apparatus 20 through the communication line 2. The storage unit 34, for example, includes a hard disk. The storage unit 34 stores a duplication of document data which is transmitted from the client apparatus 10 to the image forming apparatus 20.

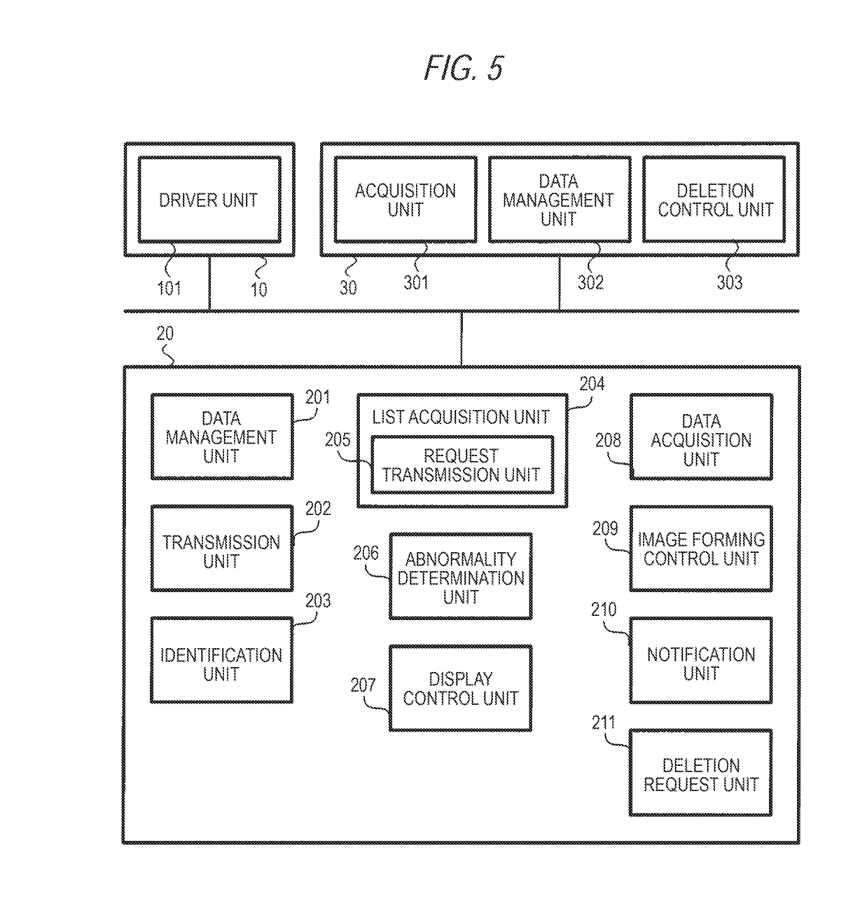

FIG. 5 is a view illustrating functional components of the image forming system 1. The client apparatus 10 includes a driver unit 101 as a functional component. The driver unit 101 is implemented when the CPU 11 executes the printer driver 17. The driver unit 101 transmits the document data to the image forming apparatus 20.

The image forming apparatus 20 includes a data management unit 201, a transmitting unit 202, an identification unit 203, a list acquisition unit 204, a request transmission unit 205, an abnormality determination unit 206, a display control unit 207, a data acquisition unit 208, an image forming control unit 209, a notification unit 210, and a deletion request unit 211 as functional components. These functional components are implemented, for example, when the CPU executes one or a plurality of programs in the control unit 21. The data management unit 201 manages the document data stored in the storage unit 23. The storage unit 23 is an example of a second storage unit. The transmission unit 202 duplicates the document data which is received from the client apparatus 10 and transmits the duplicated document data to the server apparatus 30.

The identification unit 203 identifies a user of the local device. The list acquisition unit 204 has a function as the request transmission unit 205. The request transmission unit 205 transmits a request for checking a state to another image forming apparatus 20. The abnormality determination unit 206 determines whether the error occurs in the other image forming apparatus 20 in accordance with a result of a response for the request which is transmitted from the request transmission unit 205. The list acquisition unit 204 acquires a list of the document data of the user which is stored in the other image forming apparatus 20. Specifically, if the abnormality determination unit 206 determines that no error occurs in the other image forming apparatus 20, the list acquisition unit 204 acquires a list of the document data from the other image forming apparatus 20. Meanwhile, if the abnormality determination unit 206 determines that an error occurs in the other image forming apparatus 20, the list acquisition unit 204 acquires a list of the document data from the server apparatus 30, instead of the other image forming apparatus 20.

The display control unit 207 displays the list of the document data which is acquired by the list acquisition unit 204 on the UI unit 24. The data acquisition unit 208 acquires document data which is selected from the list of the document data displayed on the UI unit 24. Specifically, if the abnormality determination unit 206 determines that no error occurs in the other image forming apparatus 20 in which the selected document data is stored, the data acquisition unit 208 acquires the document data from the other image forming apparatus 20. In contrast, if the abnormality determination unit 206 determines that an error occurs in the other image forming apparatus 20 in which the selected document data is stored, the data acquisition unit 208 acquires the document data from the server apparatus 30, instead of the other image forming apparatus 20. The image forming control unit 209 allows the image forming unit 25 to form an image in accordance with the document data acquired by the data acquisition unit 208. The notification unit 210 notifies the server apparatus 30 and the other image forming apparatus 20 that the formation of the image is completed. If the formation of the image in accordance with the document data acquired from the server apparatus 30 is completed, the deletion request unit 211 requests the server apparatus 30 to delete the document data which is stored in the other image forming apparatus 20.

The server apparatus 30 includes an acquisition unit 301, a data management unit 302, and a deletion control unit 303 as functional components. These functional components are implemented when the CPU 31 executes one or a plurality of programs. When document data of the user is transmitted from the client apparatus 10 to any one of the image forming apparatus 20, the acquisition unit 301 acquires image data from the image forming apparatus 20 which is a destination of the image data. The data management unit 302 manages the document data stored in the storage unit 34. The storage unit 34 is an example of a first storage unit. When the error of the other image forming apparatus 20 is recovered, the deletion control unit 303 deletes the document data which is used to form an image in the other image forming apparatus 20, in accordance with the request from the deletion request unit 211.

Further, in the following description, if the configurations of the image forming apparatus 20A, 20B, and 20C need to be distinguished, in the configuration of the image forming apparatus 20A, A is added to an end of the reference numeral, in the configuration of the image forming apparatus 20B, B is added to an end of the reference numeral, and in the configuration of the image forming apparatus 20C, C is added to an end of the reference numeral.

[Operation]

The user manipulates the client apparatus 10 to store his/her own document data in any one of the image forming apparatus 20A, 20B, 20C. Thereafter, the user uses a desired image forming apparatus 20 to print the document data. “Print” refers to formation of an image. In this case, the image forming apparatus 20 which is used by the user may be any one of the image forming apparatus 20A, 20B, 20C. For example, if the image forming apparatus 20A which is usually used by the user is used by the other user, the user may use a separate image forming apparatus 20B. Further, if the image forming apparatus 20C is provided in a space of the destination, the user may use the image forming apparatus 20C. Here, an example in which the user stores his/her own document data in the image forming apparatus 20A and then prints the document data using the image forming apparatus 20B will be described.

(Printing processing in normal state)

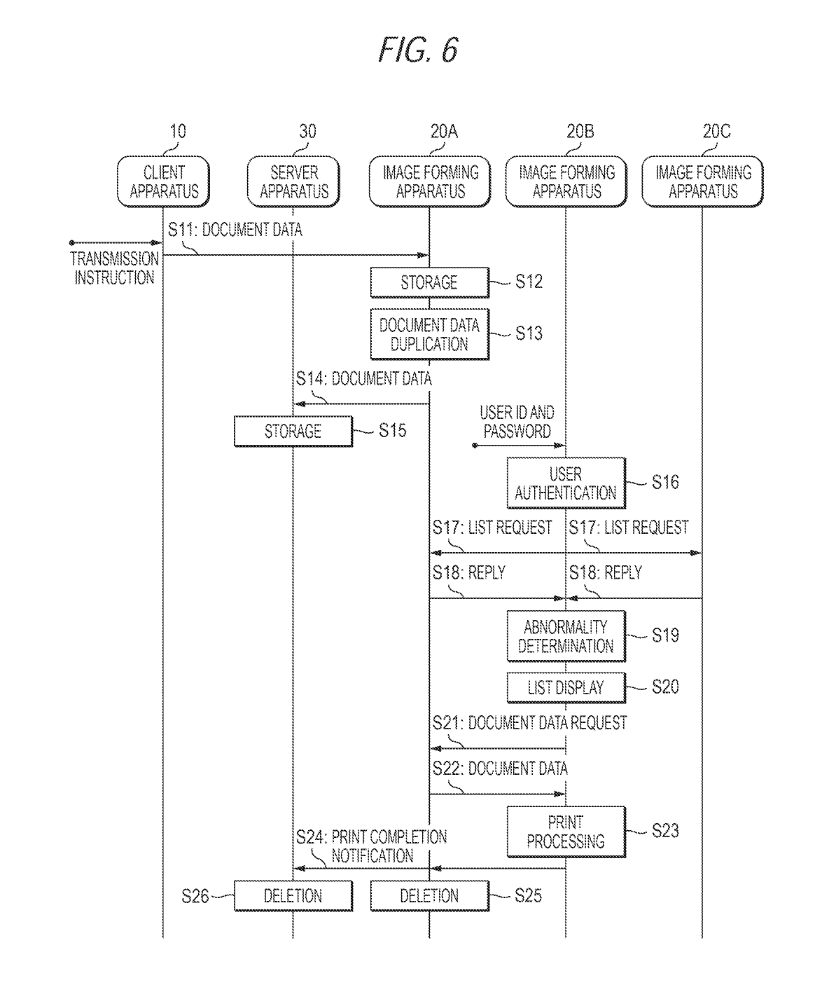

FIG. 6 is a sequence chart illustrating a printing processing in a normal state. In a normal state, the printing processing is performed when any of the image forming apparatus 20A, 20B, 20C normally operates. The user uses the manipulation unit 15 of the client apparatus 10 to designate document data to be printed and inputs an instruction that transmits the document data to the image forming apparatus 20A. When the transmission instruction is input, at step S11, the driver unit 101 transmits the designated document data to the image forming apparatus 20A. In this case, the driver unit 101 transmits the document data so as to be assigned with the user ID “user01” which identifies the user. The user ID is, for example, input when the user logs in the client apparatus 10.

When the document data is received from the client apparatus 10, at step S12, the data management unit 201A of the image forming apparatus 20A stores the received document data in the storage unit 23A. In this case, the data management unit 201A assigns a unique document ID “document01” to the document data. The transmission unit 202A duplicates the received document data at step S13 and transmits the duplicated document data to the server apparatus 30 at step S14. In this case, the transmission unit 202A transmits the document data so as to be assigned with an apparatus ID “MFP-A” which identifies the local device, in addition to the user ID “user01” and the document ID “document01” which are assigned to the document data.

When the document data is received from the image forming apparatus 20A, the acquisition unit 301 of the server apparatus 30 acquires the received document data. At step S15, the data management unit 302 stores the document data acquired by the acquisition unit 301 in the storage unit 34. As described above, a duplication of all document data which is transmitted from the client apparatus 10 to the image forming apparatus 20, but is not printed yet is stored in the storage unit 34. The data management unit 302 manages the document data stored in the storage unit 34 using the database 35.

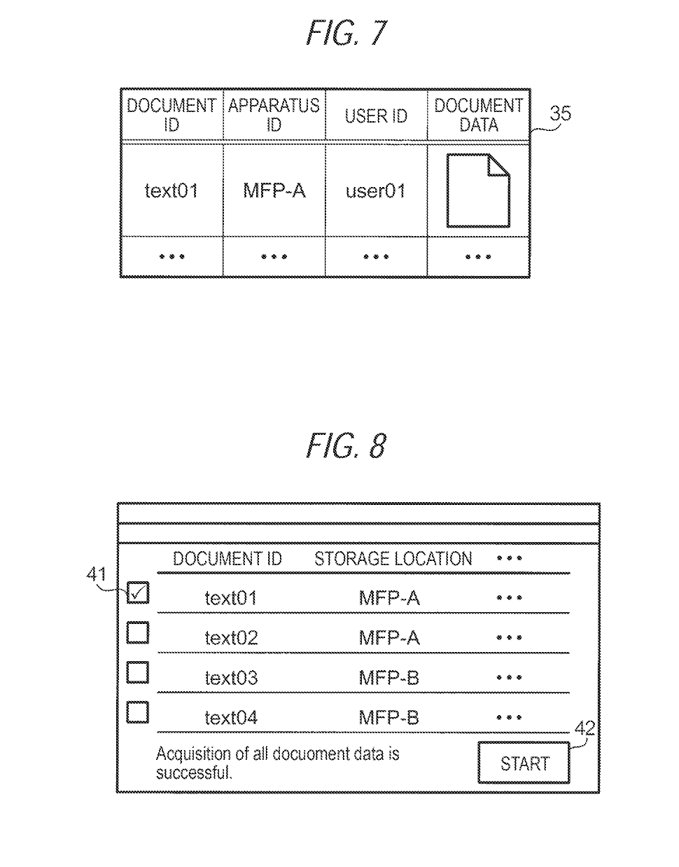

FIG. 7 is a view illustrating the database 35 which manages document data. In the database 35, the document data which is stored in the storage unit 34 and the document ID, the apparatus ID, and the user ID which are assigned to the document data are stored so as to be associated with each other. The database 35 illustrated in FIG. 7 indicates that the document data whose document ID is “document01” is stored in the image forming apparatus 20A whose apparatus ID is “MFP-A” by a user whose user ID is “user01”.

After inputting a transmission instruction, the user moves in front of the image forming apparatus 20B and inputs his/her own user ID “user01” and password “****” using the UI unit 24B. When the user ID and the password are input, at step S16, the identification unit 203B of the image forming apparatus 20B compares the input user ID and password with the authentication database 26 stored in the storage unit 23B to perform user authentication. When the set of the user ID “user01” and the password “****” is included in the authentication database 26, the user authentication succeeds and the user logs in the image forming apparatus 20B. In contrast, if the set of the user ID and the password is not included in the authentication database 26, the user authentication is failed. In this case, the user cannot log in the image forming apparatus 20B.

When the user logs in the image forming apparatus 20B, the user uses the UI unit 24B to input an instruction to display a list of the document data. When the display instruction is input, the list acquisition unit 204B acquires the list of the document data of the user who logs in the image forming apparatus 20B. Specifically, at step S17, the list acquisition unit 204B transmits a list transmitting request (hereinafter, referred to as a “list request”) of the document data of the user who logs in the image forming apparatus 20B to the image forming apparatus 20A and 20C which are registered in advance. The list request includes the user ID “user01”. Further, the list acquisition unit 204B supplies the list transmitting request for the document data of the user who logs in the image forming apparatus 20B to the data management unit 201B of the local device. The list request also includes the user ID “user01”.

If no error occurs in the image forming apparatus 20A, at step S18, the data management unit 201A receives the list request from the image forming apparatus 20B and replies to the request. Specifically, the data management unit 201A determines whether the document data to which the user ID “user01” included in the received list request is assigned is stored in the storage unit 23A. When target document data is stored in the storage unit 23A, the data management unit 201A creates a list of the document data and transmits the list to the image forming apparatus 20B. The list of the document data, for example, includes a document ID which is assigned to the document data and information indicating a location where the document data is stored. The information indicating the location where the document data is stored is, for example, an apparatus ID “MFP-A” of the image forming apparatus 20A. In contrast, if the target document data is not stored in the storage unit 23A, the data management unit 201A returns a response indicating that the document data is not stored in the storage unit 23A to the image forming apparatus 20B. The image forming apparatus 20C and the data management unit 201B also return the same response as the image forming apparatus 20A.

At step S19, the abnormality determination unit 206B determines whether the error occurs in the image forming apparatus 20A and 20C depending on whether there is a response for the list request transmitted at step S17. For example, if the responses for the list request are returned from the image forming apparatus 20A and 20C, respectively, the abnormality determination unit 206B determines that no error occurs in any of the image forming apparatus 20A and 20C. In this case, when the list acquisition unit 204B receives the responses from the image forming apparatus 20A and 20C and the data management unit 201B, respectively, the list acquisition unit 204B determines that the list of the document data of the user is provided. If it is determined that the list of the document data of the user is provided, the list acquisition unit 204B combines the lists of the document data received from the image forming apparatus 20A and 20C, and the data management unit 201B and supplies the combined list to the display control unit 207B. At step S20, the display control unit 207B displays the list of the document data supplied from the list acquisition unit 204B on the UI unit 24B.

FIG. 8 is a view illustrating a list of the document data which is displayed in this case. In the list of the document data, information such as a document ID or a storage location with respect to the document data of a user whose user ID is “user01” is displayed. The list of the document data illustrated in FIG. 8 indicates that, among the document data of the user whose user ID is “user01”, document data whose document ID is “document01” and document data whose document ID is “document02” are stored in the image forming apparatus 20A and document data whose document ID is “document03” and document data whose document ID is “document04” are stored in the image forming apparatus 20B.

Further, on the UI unit 24B, a check box 41 for selecting document data to be printed and a start button 42 which instructs to start printing are displayed together with the list of the document data. Here, an example in which document data whose document ID is “document01” is printed will be described. In this case, the user uses the UI unit 24B to fill the check box 41 which is displayed next to the document ID “document01” and then presses the start button 42 to input the print starting instruction.

When the print starting instruction is input, the data acquisition unit 208B acquires the document data whose document ID is “document01”. Here, the abnormality determination unit 206B determines that no error occurs in the image forming apparatus 20A in which the document data is stored at step S19 above. In this case, the data acquisition unit 208B acquires the document data whose document ID is “document01” from the image forming apparatus 20A. Specifically, at step S21, the data acquisition unit 208B transmits the request (hereinafter, referred to as “document data request”) for transmitting the document data whose document ID is “document01” to the image forming apparatus 20A. The test data request includes the document ID “document01”.

If the document data request is received from the image forming apparatus 20B, at step S22, the data management unit 201A of the image forming apparatus 20A reads the document data to which the document ID is assigned, which is included in the document data request, from the storage unit 23A and transmits the document data to the image forming apparatus 20B. When the document data is received from the image forming apparatus 20A, at step S23, an image forming control unit 209B of the image forming apparatus 20B controls the image forming unit 25B to print the received document data. By doing this, the document data whose document ID is “document01” is printed in the image forming apparatus 20B.

When the printing processing is completed, at step S24, the notification unit 210B transmits the printing completion notification to the image forming apparatus 20A and the server apparatus 30. The printing completion notification includes the document ID “document01”. When the printing completion notification is received from the image forming apparatus 20B, at step S25, the data management unit 201A of the image forming apparatus 20A deletes the document data to which the document ID included in the printing completion notification is assigned from the storage unit 23A. Similarly, at step S26, the data management unit 302 of the server apparatus 30 deletes the document data to which the document ID included in the printing completion notification received from the image forming apparatus 20B is assigned from the storage unit 24. By doing this, the document data whose document ID is “document01” is deleted from the image forming apparatus 20A and the server apparatus 30.

(Printing processing in abnormal state)

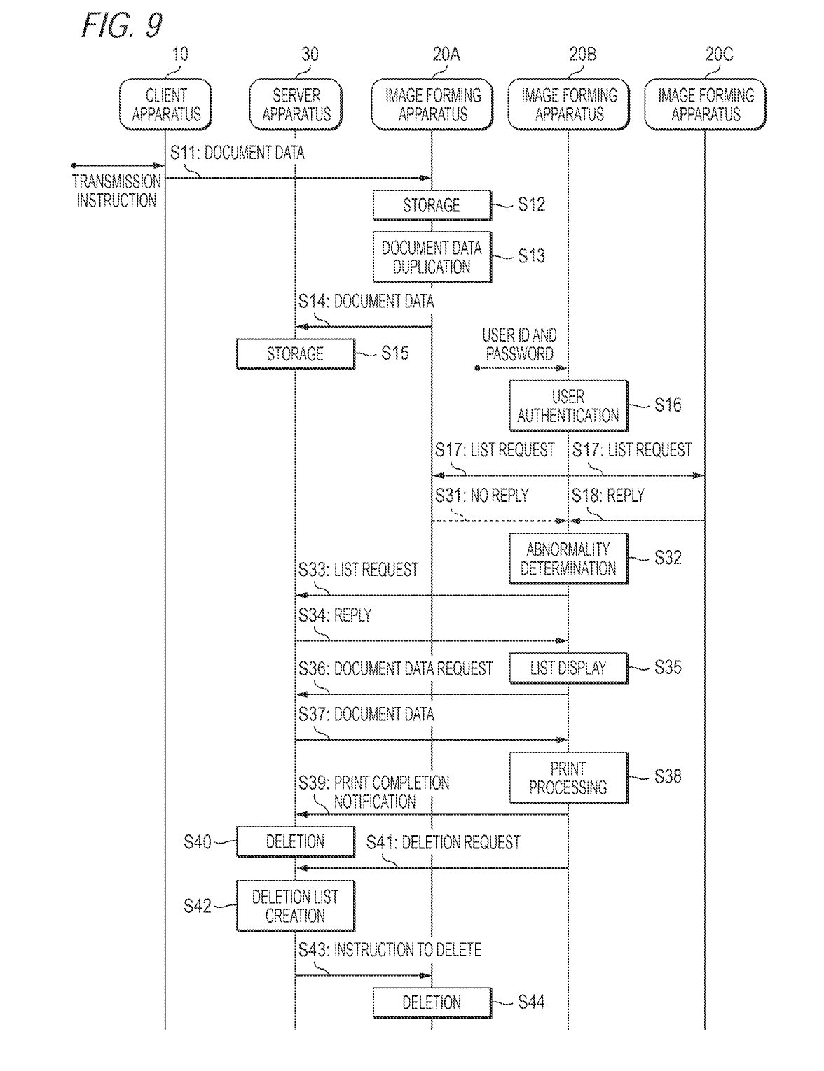

FIG. 9 is a sequence chart illustrating a printing processing in an abnormal state. The printing processing in an abnormal state is performed when an error occurs in the image forming apparatus 20A or 20C. Here, an example when a power of the image forming apparatus 20A is turned off will be described. In the above-described printing processing in the normal state, the image forming apparatus 20B cooperates with the image forming apparatus 20A or 20C to exchange the list of the document data or the document data to obtain these data without having intervention of the server apparatus 30. But, if the power of the image forming apparatus 20A is turned off, the list of the document data or the document data may not be acquired from the image forming apparatus 20A. Therefore, in the printing processing during the abnormal state, the server apparatus 30 serves to provide the list of the document data or the document data instead of the image forming apparatus 20A. The server apparatus 30 may provide a service using so-called cloud computing. The processings at steps S11 to S17 are the same as the printing processing in the normal state so that the description thereof will be omitted.

When the power of the image forming apparatus 20A is turned off, even though the image forming apparatus 20B transmits the list request at step S17, at step S31, the response for the list request is not returned from the image forming apparatus 20A. When a predetermined time has elapsed while no response is transmitted from the image forming apparatus 20A, the list request is timed-out. In this case, at step S32, the abnormality determination unit 206B determines that the error occurs in the image forming apparatus 20A. If the abnormality determination unit 206B determines that the error occurs in the image forming apparatus 20A, the list acquisition unit 204B acquires the list of the document data from the server apparatus 30, instead of the image forming apparatus 20A. Specifically, at step S33, the list acquisition unit 204B transmits the list transmitting request (hereinafter, referred to as a “list request”) of the document data stored in the image forming apparatus 20A among the document data corresponding to the user ID “user01” to the server apparatus 30. The list request includes the user ID “user01” and the apparatus ID “MFP-A” of the image forming apparatus 20A.

If the list request is received from the image forming apparatus 20B, at step S34, the server apparatus 30 replies to the list request. Specifically, the data management unit 302 of the server apparatus 30 refers to the database 35 to determine whether the document data to which the user ID “user01” and the apparatus ID “MFP-A” included in the received list request are assigned is stored in the storage unit 34. As illustrated by the database 35 of FIG. 7, if the target document data is stored in the storage unit 34, the data management unit 302 creates the list of the document data and transmits the list to the image forming apparatus 20B. The list of the document data, for example, includes a document ID which is assigned to the document data and information indicating a location where the document data is stored. The information indicating the location where the document data is stored, for example, includes an apparatus ID which is assigned to the document data and an apparatus ID “Serv” which identifies the server apparatus 30. In contrast, if the target document data is not stored in the storage unit 34, the data management unit 302 returns a response indicating that the document data is not stored in the storage unit 34 to the image forming apparatus 20B. Further, the data management unit 201C of the image forming apparatus 20C and the data management unit 201B of the image forming apparatus 20B return the responses which are same as in the printing processing in the normal state as described above.

When receiving the responses from the server apparatus 30, the image forming apparatus 20C and the data management unit 201B, respectively, the list acquisition unit 204B determines that the list of the document data of the user is provided. If it is determined that the list of the document data of the user is provided, the list acquisition unit 204B combines the lists of the document data received from the server apparatus 30, the image forming apparatus 20C or the data management unit 201B, and supplies the combined list to the display control unit 207B. At step S35, the display control unit 207B displays the list of the document data supplied from the list acquisition unit 204B on the UI unit 24B.

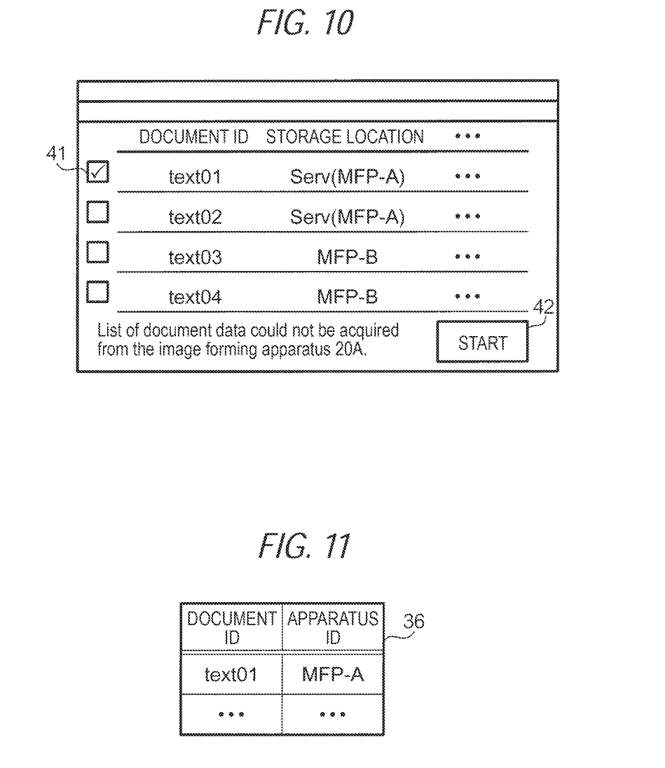

FIG. 10 is a view illustrating a list of the document data which is displayed in this case. The list of the document data illustrated in FIG. 10 indicates that the document data whose document ID is “document01” and the document data whose document ID is “document02” are stored in the image forming apparatus 20A but the error occurs in the image forming apparatus 20A so that the list of the above document data is acquired from the server apparatus 30. Further, on the UI unit 24B, a message indicating that the list of the document data is not acquired from the image forming apparatus 20A is displayed. Here, an example in which document data whose document ID is “document01” is printed will be described. In this case, the user uses the UI unit 24B to fill the check box 41 which is displayed next to the document ID “document01” and then presses the start button 42 to input the print starting instruction.

When the print starting instruction is input, the data acquisition unit 208B acquires the document data whose document ID is “document01”. Here, the abnormality determination unit 206B determines that an error occurs in the image forming apparatus 20A in which the document data is stored at step S32. In this case, the data acquisition unit 208B acquires the document data from the server apparatus 30, instead of the image forming apparatus 20A. Specifically, at step S36, the data acquisition unit 208B transmits the request (hereinafter, referred to as “document data request”) for transmitting the document data whose document ID is “document01” to the server apparatus 30. The text data request includes the document ID “document01”.

If the document data request is received from the image forming apparatus 20B, at step S37, the data management unit 302 of the server apparatus 30 reads the document data to which the document ID included in the document data request is assigned from the storage unit 34 and transmits the document data to the image forming apparatus 20B. When the document data is received from the server apparatus 30, at step S38, an image forming control unit 209B of the image forming apparatus 20B controls the image forming unit 25B to print the received document data. By doing this, the document data whose document ID is “document01” is printed in the image forming apparatus 20B.

When the printing processing is completed, at step S39, the notification unit 210B transmits the printing completion notification to the server apparatus 30 and the image forming apparatus 20A. The printing completion notification includes the document ID “document01”. When the printing completion notification is received in the image forming apparatus 20B, at step S40, the data management unit 302 of the server apparatus 30 deletes the document data to which the document ID included in the printing completion notification is assigned from the storage unit 34. By doing this, the document data whose document ID is “document01” is deleted from the server apparatus 30. Further, since error occurs in the image forming apparatus 20A, the printing completion notification is not received by the image forming apparatus 20A.

Further, at step S41, a deletion request unit 211B of the image forming apparatus 20B transmits a deletion request of the document data whose document ID stored in the image forming apparatus 20A is “document01” to the server apparatus 30. The deletion request includes the document ID “document01” and the apparatus ID “MFP-A” of the image forming apparatus 20A. When the deletion request is received from the image forming apparatus 20B, at step S42, the deletion control unit 303 of the server apparatus 30 creates a deletion list 36 which manages the document data to be deleted.

FIG. 11 is a view illustrating a deletion list 36. In the deletion list 36, the document ID and the apparatus ID which are included in the deletion request are stored so as to be associated with each other. The deletion list 36 illustrated in FIG. 11 indicates that the document data whose document ID is “document01” to be deleted is stored in the image forming apparatus 20A.

At step S43, the deletion control unit 303 transmits an instruction to delete the document data to the image forming apparatus 20, based on the deletion list 36, at a predetermined timing. As illustrated by the deletion list 36 of FIG. 11, if the image data whose document ID is “document01” to be deleted is stored in the image forming apparatus 20A, the deletion control unit 303 transmits the instruction to delete the document data to the image forming apparatus 20A. The deletion instruction includes the document ID “document01”.

If the data management unit 201A of the image forming apparatus 20A receives the deletion instruction from the server apparatus 30 after the power is turned on, at step S44, the data management unit 201A deletes the document data to which the document ID included in the deletion instruction is assigned from the storage unit 23A. When the deletion of the document data is completed, the data management unit 201A returns a deletion completion notification to the server apparatus 30. Further, if the deletion completion notification is not returned from the image forming apparatus 20A, the deletion control unit 303 of the server apparatus 30 repeatedly transmits the above-mentioned deletion instruction at a predetermined interval of time until the deletion completion notification is returned from the image forming apparatus 20A.

If the processings at steps S41 to S44 are not performed, the document data which has been printed remains to be stored in the image forming apparatus 20A. In this case, the error of the image forming apparatus 20A is recovered, the list of the document data including the information of the document data is created so that the information of the document data which has been already printed is presented to the user, again. However, in the embodiment, when the error of the image forming apparatus 20A is recovered, the document data which has been printed is promptly deleted from the image forming apparatus 20A. Accordingly, only information of the document data which has not been printed is presented to the user.

According to the above-described embodiment, even when an error occurs in the image forming apparatus 20 in which the document data is stored by the user, the document data may be printed using another desired image forming apparatus 20. Further, when an error does not occur in the other image forming apparatus 20, the image forming apparatus 20 cooperate with each other to exchange the list of the document data or the document data so that the time to obtain the list of the document data or the document data is reduced as compared with a case when the information is always acquired from the server apparatus 30. Further, for example, if the server apparatus 30 provides a service using so-called cloud computing, the service fee may be charged in accordance with the usage amount. However, even in this case, the usage of the server apparatus 30 is minimized so that the usage cost of the server apparatus 30 may be suppressed as compared with the case when the list of the document data or the document data is always acquired from the server apparatus 30.

### Modified Embodiments

The above-described embodiment is an example of the present invention and may be modified as follows. Further, the following modified embodiments may be combined with each other.

### (1) Modified Embodiment 1

In the above-described embodiment, as an example of the abnormal state of the image forming apparatus 20, it is described that the power of the image forming apparatus 20 is turned off. However, the abnormal state of the image forming apparatus 20 is not limited to the state when the power is turned off. The abnormal state refers to a state when there is a trouble to transmit the list of the document data or the document data. For example, the abnormal state may include a state when the communication is not performed, an out-of-order state, or a state which transits into a sleep mode. The sleep mode refers to an operation mode when a part of the image forming apparatus 20 is stopped. When the image forming apparatus 20 transits into the sleep mode, the list of the document data or the document data is not transmitted unless the image forming apparatus 20 returns into a normal operation mode. Therefore, the state which transits into the sleep mode may be referred to as a state where there is a trouble to transmit the data.

Further, in the above-described embodiment, it is described that when there is no response for the list request, it is determined that the error occurs in the other image forming apparatus 20. However, the result of the response indicating that the error occurs in the other image forming apparatus 20 is not limited to the result indicating that there is no response from the other image forming apparatus 20. For example, if information indicating occurrence of an error or information indicating the transition into the sleep mode is received from the other image forming apparatus 20, the reception of these information may be used as a result of the response indicating that the error occurs in the other image forming apparatus 20. Hereinafter, specific examples of the modified embodiment will be described.

For example, when the image forming apparatus 20A is not connected to the communication line 2 so that the image forming apparatus 20A may not communicate with the image forming apparatus 20B, at step S17 illustrated in FIG. 6, the list request transmitted from the image forming apparatus 20B does not reach the image forming apparatus 20A. In this case, since the response for the list request is not returned from the image forming apparatus 20A, the abnormality determination unit 206B determines that the error occurs in the image forming apparatus 20A. In this case, the list of the document data or the document data of the user may be acquired from the server apparatus 30, instead of the image forming apparatus 20A which cannot communicate, similarly as in the above-described printing processing in the abnormal state.

Further, when an error occurs in the storage unit 23A of the image forming apparatus 20A, if the list request is received from the image forming apparatus 20B, the data management unit 201 A returns an error code indicating a type of error with respect to the list request. If the error code is received from the image forming apparatus 20A, the abnormality determination unit 206B determines that the error occurs in the image forming apparatus 20A. In this case, the list of the document data or the document data of the user may be acquired from the server apparatus 30, instead of the image forming apparatus 20A in which an error occurs, similarly as in the above-described printing processing in the abnormal state.

Further, when the image forming apparatus 20A transits into the sleep mode, if the list request is received from the image forming apparatus 20B, the data management unit 201A returns the sleep information indicating the transition into the sleep mode with respect to the list request. When the sleep information is received from the image forming apparatus 20A, the abnormality determination unit 206B determines that the error occurs in the image forming apparatus 20A. In this case, the list of the document data or the document data of the user may be acquired from the server apparatus 30, instead of the image forming apparatus 20A which transits into the sleep mode, similarly as in the above-described printing processing in the abnormal state. When the image forming apparatus 20 transits into the sleep mode, it takes time to return to the normal operation mode. Therefore, as compared with a case when the list of the document data or the document data is acquired after returning the image forming apparatus 20 into the normal operation mode, it takes less time to obtain the list of the document data or the document data when the information is acquired from the server apparatus 30.

Further, if the image forming apparatus 20 has a plurality of levels of sleep mode, the reply may be varied depending on the level of the sleep mode. Here, an example in which the image forming apparatus 20A has a shallow sleep mode and a deep sleep mode will be described. The shallow sleep mode refers to a sleep mode in which a stopped portion is smaller than that of the deep sleep mode. Generally, it takes less time to return the image forming apparatus 20A from the shallow sleep mode to the normal operation mode than time to return the image forming apparatus 20A from the deep sleep mode to the normal operation mode.

When the image forming apparatus 20A transits into the shallow sleep mode, if the image forming apparatus 20A receives the list request from the image forming apparatus 20B, the image forming apparatus 20A returns from the sleep mode to the normal operation mode. When the image forming apparatus 20A returns to the normal operation mode, the data management unit 201A replies the same response as replied at step S18 illustrated in FIG. 6 with respect to the received list request. In this case, the list of the document data or the document data of the user is acquired from the image forming apparatus 20A similarly to the above-described printing processing in the normal state.

In contrast, if the image forming apparatus 20A transits into the deep sleep mode, even though the image forming apparatus 20A receives the list request from the image forming apparatus 20B, the image forming apparatus 20A does not return from the deep sleep mode to the normal operation mode. The data management unit 201A returns the above-mentioned sleep mode with respect to the list request. In this case, the list of the document data or the document data of the user may be acquired from the server apparatus 30, instead of the image forming apparatus 20A which transits into the deep sleep mode, similarly as in the above-described printing processing in the abnormal state.

### (2) Modified Embodiment 2

In the above-described embodiment, it is described that the instruction to delete the document data is transmitted from the server apparatus 30 to the image forming apparatus 20 at the predetermined interval of time. However, the server apparatus 30 may transmit the deletion instruction in accordance with an inquiry from the image forming apparatus 20. For example, when the power is turned on, the image forming apparatus 20A transmits a notification indicating that the image forming apparatus 20A is recovered from the error to the server apparatus 30. When receiving the notification from the image forming apparatus 20A, the server apparatus 30 transmits the instruction to delete the document data to the image forming apparatus 20A, similarly to step S43 illustrated in FIG. 9. In the above-described embodiment, for example, if the error of the image forming apparatus 20A is not promptly recovered, the server apparatus 30 needs to repeatedly transmit the deletion instruction several times. In contrast, according to the modified embodiment, the server apparatus 30 transmits the deletion instruction when the error of the image forming apparatus 20A is recovered so that there is no need to repeatedly transmit the deletion instruction several times.

### (3) Modified Embodiment 3

In the above-described embodiment, it is described that the duplicated document data is transmitted from the image forming apparatus 20A, 20B, the server apparatus 30. However, the device that transmits the duplicated document data to the server apparatus 30 is not limited to the image forming apparatus 20A. For example, the duplicated document data may be transmitted from the client apparatus 10 to the server apparatus 30. In this case, the driver unit 101 of the client apparatus 10 duplicates the document data which is transmitted to the image forming apparatus 20A and transmits the duplicated document data to the server apparatus 30. In this case, the driver unit 101 transmits the document data so as to be assigned with the user ID, the unique document ID, and the apparatus ID of the image forming apparatus 20A. According to the modified embodiment, the image forming apparatus 20 does not need to transmit the document data so that the load to the image forming apparatus 20 is reduced.

### (4) Modified Embodiment 4

The list request which has been described in the embodiment serves to request to transmit the list of the document data and also serves as a request to check the state of the other image forming apparatus 20. However, a request for checking the state of the other image forming apparatus 20 may be transmitted in addition to the list request. In this case, the request transmission unit 205 transmits the request for checking the state of the other image forming apparatus 20 before transmitting the list request. The abnormality determination unit 206 determines whether the error occurs in the other image forming apparatus 20 by the result of the response for the request transmitted from the request transmission unit 205.

### (5) Modified Embodiment 5

In the above-described embodiment, the list of the document data or the document data is exchanged between the image forming apparatus 20A, 20B, 20C which belong to the same group. However, for example, in some cases, the user instructs to display the list of the document data which is stored in an image forming apparatus 20D which belongs to a separate group or print the document data. In this case, the image forming apparatus 20A, 20B, 20C may obtain the list of the document data or the document data from the server apparatus 30.

### (6) Modified Embodiment 6

In the above-described embodiment, it is described that the user authentication is performed using the user ID and the password of the user. However, the method of identifying the user is not limited to the user authentication using the user ID and the password. For example, the user may be identified only using the user ID. Further, the image forming apparatus 20 may read biological information of the user using a device which reads the biological information such as a finger print or vein and identify the user using the read biological information. Further, if the user ID or the password is recorded in an IC (integrated circuit) card, the image forming apparatus 20 may read the information from the IC card using an IC card reader.

### (7) Modified Embodiment 7

The document data described in the above-described embodiment is an example of the image data which is used to form an image. The image data may be, for example, data indicating an image or a FIG.

### (8) Modified Embodiment 8

The client apparatus 10, the image forming apparatus 20, and the server apparatus 30 do not need to include all of the functional components described in the above embodiment. For example, if the user specifies the document ID of the document data to be printed using the UI unit 24, the image forming apparatus 20 does not need to display the list of the document data. In this case, the image forming apparatus 20 does not need to include the list acquisition unit 204 and the display control unit 207 which are illustrated in FIG. 5.

### (9) Modified Embodiment 9

In the above-described embodiment, it is described that the image forming system 1 includes three image forming apparatus 20. However, the number of the image forming apparatus 20 is not limited to three. For example, if the number of users is large, the image forming system 1 may include four or more image forming apparatus 20.

### (10) Modified Embodiment 10

The program which is executed in the client apparatus 10, the image forming apparatus 20, and the server apparatus 30 may be downloaded through a communication line such as the Internet. Further, the program may be provided so as to be recorded in a computer readable recording medium such as a magnetic recording medium (a magnetic tape or a magnetic disk), an optical recording medium (an optical disk), a magnetooptical recording medium, or a semiconductor memory.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system, comprising:
a server apparatus; and
a plurality of image forming apparatuses,
wherein the server apparatus includes:
an acquisition unit that, when image data of a user is transmitted from a client apparatus to any one of the plurality of image forming apparatus, obtains the image data from the client apparatus or the image forming apparatus which is a destination of the image data; and
a first storage unit that stores the image data acquired by the acquisition unit,
each of the plurality of image forming apparatuses, includes:
a second storage unit that stores the image data which is transmitted from the client apparatus to a local device as the image forming apparatus;
an identification unit that identifies a user of the local device;
a request transmission unit that transmits a request to check a state of another image forming apparatus;
a data acquisition unit that, when a result of a response for the request indicates that an error occurs in said another image forming apparatus, obtains image data of the user who is identified by the identification unit from the server apparatus; and
an image forming unit that forms an image in accordance with the image data acquired by the data acquisition unit.

2. The image forming system of claim 1,
wherein when the result of the response for the request indicates that an error does not occur in said another image forming apparatus, the data acquisition unit acquires the image data of the user from said another image forming apparatus.

3. The image forming system of claim 1,
wherein each of the image forming apparatuses further includes:
a deletion request unit that, when the formation of the image in accordance with the image data acquired from the server apparatus is completed, requests the server apparatus to delete the image data stored in said another image forming apparatus, and
the server apparatus further includes:
a deletion control unit that, when the error of said another image forming apparatus is recovered, deletes the image data which is used to form the image in said another image forming apparatus, in accordance with the request from the deletion request unit.

4. An image forming apparatus, comprising:
a communication unit that communicates with a server apparatus and another image forming apparatus;
an identification unit that identifies a user of a local device as the image forming apparatus;
a request transmission unit that transmits a request to check a state to another image forming apparatus through the communication unit;
a data acquisition unit that, when a result of a response for the request indicates that an error occurs in said another image forming apparatus, obtain image data of the user who is identified by the identification unit from the server apparatus through the communication unit; and
an image forming unit that forms an image in accordance with the image data acquired by the data acquisition unit.

5. An image forming method of an image forming apparatus, comprising:
communicating with a server apparatus and another image forming apparatus;
identifying a user of a local device as the image forming apparatus;
transmitting a request to check a state to another image forming apparatus through the communication;
when a result of a response for the request indicates that an error occurs in said another image forming apparatus, obtaining image data of the identified user from the server apparatus through the communication; and
forming an image in accordance with the acquired image data.
